(19) United States
(12) Patent Application Publication
(10) Pub. No.: US 2014/0327308 A1
(43) Pub. Date: Nov. 6, 2014

(54) Solid-State Bi-Directional Balanced Energy Conversion and Management System

(71) Applicant: Palmetto Power, LLC, Charleston, SC (US)

(72) Inventors: Anthony Cargile, Charleston, SC (US); Fred Fabian, Charleston, SC (US)

(73) Assignee: Palmetto Power, LLC, Charleston, SC (US)

(21) Appl. No.: 14/269,918

(22) Filed: May 5, 2014

Related U.S. Application Data
(60) Provisional application No. 61/819,639, filed on May 5, 2013.

(51) Int. Cl. H02J 3/00

(52) U.S. Cl. CPC H02J 3/00
USPC 307/31; 323/350

(57) ABSTRACT

The present invention is a modular solid-state bi-directional energy conversion system, which regardless of scale and directional flow, measures, adjusts, harvests, and manages the conversion of frequency, phase, and voltage between the primary and secondary sides providing for safer, efficient, lower-cost energy distribution. The system may include voltage suppression devices at either of its connection sides; network communication devices for system diagnostics, reporting, metering, and power distribution grid management; and on-board communication devices for field maintenance and other applications.

### CROSS-REFERENCE TO RELATED APPLICATIONS

Provisional Application No. 61/819,639—Filed May 5, 2013

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The present invention relates to conversion and management of electrical energy, ranging from utility level transformers to consumer appliances on all scales.

### BACKGROUND OF THE INVENTION

Existing electrical power grids rely on transformers that function based on Faraday's Law of Induction, which explains that a current flowing through one coil of wire sharing a magnetically-excitable core with another coil of wire will induce a current in the second coil of wire, mathematically stated:

$${∮}_{\partial S} \vec{E} \cdot d \vec{l} = - \int {\int }_{S} \frac{\partial \vec{B}}{\partial t} \cdot d \vec{A} ≡ ∇ \times \vec{E} = - \frac{\partial \vec{B}}{\partial t}$$

Qualitatively stated: The electric field (E) within the bounds of a surface (S) is opposite in sign to the surface's entire area's worth of changing magnetic field (B) over time (t).

Given a ratio of turns between one coil of wire within a transformer and another, the potential induced in a coil of wire by an energized coil of wire, sharing a magnetically-excitable metallic core, is mathematically modeled as follows given the turns of wire and voltage in a primary and secondary coils.

$$\frac{{V}_{S}}{{V}_{P}} = \frac{{N}_{S}}{{N}_{P}} = \frac{{I}_{P}}{{I}_{S}}$$

The ratio of the voltage flowing through the secondary winding to the voltage flowing through the primary winding (V subscript S and V subscript P, respectively) is equal to the ratio of the number of turns contained within the secondary coil (N subscript S) to the number of turns within the primary coil of wire (N subscript P). The currents of the coils (I's) are equated as well albeit in an inverse fashion, to satisfy the law of conservation of energy. Losses during the transformation process are omitted, for simplification.

Of note is the bi-directionality of the transformer equation: whether a current is induced in the secondary by the primary's current or current is induced in the primary by the secondary's current, power will cross the core.

Transformers are positioned at “step-down substations” and “secondary customers” in the electrical distribution at its final stage of delivery of electricity to end users and the redistribution of renewable energy sources. A distribution system's network carries electricity from the transmission system and delivers it to utility customers. Typically, the network would include medium-voltage power lines, substations step-down transformers, and ultimately the delivery of power to pole (and other) transformers and low-voltage distribution wiring.

Existing transformers currently in use in power grids based on the above principles use many windings around very large cores. The core is the most expensive element within the transformer.

Existing transformers currently in use in power grids are unidirectional. A separate grid tie inverter device is used to supply renewable energy back into the network power distribution system.

There are needs to reduce the cost of transformers, safely and efficiently introduce renewable energy sources into the power distribution grid, and capture and reutilize energy that is currently wasted after it passes through consumer devices.

### BRIEF SUMMARY OF THE INVENTION

The present invention is a modular solid state bidirectional energy conversion and management system that can replace existing power transformers and grid tie inverters, and additionally can be scaled down for use in individual electrical devices of all kinds.

Among the many benefits of the invention, its use of solid state components allows for less core material in the transformer and thus vastly reduces manufacturing costs; it addresses needs for efficient and safe allocation of energy bidirectionally (to and from the consuming user); and it harvests energy from renewable sources and wasted energy that has passed through consumer devices.

The invention takes primary energy feeds in the form of a [2-input/3-output] split-phase, and a [3/4-input/3/4-output] three phase variant used by polyphase systems.

Additionally, the invention's form can be easily adapted to incorporate multiple variations of inputs and outputs in one manufactured form in addressing both single phase and polyphase systems.

The invention implements bi-directional switching, which allows use and redistribution of energy sources, including the secondary side.

Automatic energy conversion and respective directional flow (primary-to-secondary or secondary-to-primary) is a feature managed by the device's control circuitry and is also capable of switching power conversion scalable to high power levels.

The technology within the device utilizes solid-state discrete components to manipulate the input waveform (from either the primary or secondary direction). Use of solid-state switching devices in a controlled and systematic layout allows reductions in the amount of required metal for transformer manufacturing, but retains the use of an iron core transformer for optimal voltage conversion and galvanic isolation.

Integrated into its design, this invention features bi-directional noise attenuation and power surge suppression at both primary and secondary connections.

Phase analysis performed on both primary and secondary connections of the invention allow the device's solid-state control circuitry to precisely control switching action for both synchronous rectification and low harmonic distortion inversion. This controlled switching better maintains a power factor of near unity so that the primary and secondary connections emulate a purely resistive load.

Furthermore, bi-directional supply frequency independence to loads at the power distribution level ensures that the frequency expected by loads is consistent with expectations regardless of current supply frequency levels in either direction. Regardless of the direction of energy conversion between primary and secondary, the device efficiently manages the conversion of frequency, phase, and voltage.

The device provides energy recovery through its conversion of neutral/return currents back into usable energy through the use of DC rectification inline with the bi-directional switching of power. The efficient conversion of energy from supply-to-load regardless of direction is dependent on wide-scale power conditions (e.g. grid loads at any point in time) to enable efficient conversion of energy as needed in either direction, maintaining a matched supply and demand at any scale. This process is noted for its potential to mitigate global warming profitably on a large scale.

The control circuitry also allows automatic and remote diagnostic capabilities with a secure interface for being queried or automatically relaying this information. Remote access, data queries, sub-grouping, and process modification capabilities allow dynamic control and use in managing power distribution.

The core primary, secondary and control circuitry elements of the device can be manufactured and positioned modularly in order to facilitate efficient maintenance of the device.

### BRIEF DESCRIPTION OF THE DRAWINGS

The drawings illustrate embodiments of the elements of the invention. The drawings use standard electrical engineering symbols for discrete semiconductors, passive components (resistors, capacitors, inductors) in addition to a graphical rendering of electric transformers wired for series-parallel operation within the device's constraints.

FIG. 1 illustrates the existing widespread alternating current power transmission and distribution system, noting the transformers within that distribution. The historic view of this distribution system is that power flows from left to right, originating at some type of station generating electrical power from mechanical energy to the ultimate end users of that energy. The most notable difference in FIG. 1 from previous perceptions is the emerging element of renewable energy sources at the end user along the distribution system. When a service drop is capable of generating more energy than it consumes at any point in time, the energy needs to be “fed” back into the power distribution system to power other service drops. This is accomplished when the service drops employ a solar panel array, wind turbine or other form of power generating system past the electrical utility demarcation point. The present system requires the use of a “grid tie inverter” to invert the direct current electricity and match its electrical waveform to that of the power line grid in order to feed it back onto the grid. This existing system does not allow for integrated power control or power cleansing (filtering) at the service drop level.

FIG. 2 illustrates a simple model of an electrical transformer. This design is well known and deployed within the existing power infrastructure. In brief explanation, voltage placed across the primary winding of the transformer will have the circular magnetic field surrounding the wire created by the changing amplitude of current concentrated into the metallic core of the transformer in the form of magnetic energy (denoted as the “main flux” within the illustration). This magnetic energy, some of which is dissipated as “leakage flux” within the magnetic core, induces a voltage within the secondary coil of wire that alternates at the same frequency 180 degrees out of the phase of the primary voltage's alternating current. The amplitude of the voltage induced within the secondary winding is set by the ratio of turns between the primary and secondary windings of wire, e.g. 10,000 volts wound 1000 times as the primary winding of a magnetic-core transformer will induce a secondary potential of 100 volts within a secondary winding of 10 turns, neglecting any leakage flux losses. Power as the product of voltage and current is conserved throughout this process except for losses incurred within the transformer (leakage flux, eddy currents, and heat all contribute to such losses). Therefore, when a high voltage flows through a primary winding and a secondary winding at a much lower turn ratio is connected to a load which consumes power, the load will have a lower voltage, but higher current available to it. Multiple secondaries can be wound around the transformer to “tap” or “split” the voltage on the secondary into one or more segments for configurable voltage and current levels, with a common example being “split-phase” transformers where a secondary winding has a grounded “center tap” conductor connected to the centermost location of the secondary winding so that the potential between any outermost winding connection and the “center tap” is exactly half of the total electric potential available between each outermost-connected conductor. Multiple coils connected in a series of windings configuration will effectively split the voltage amongst the windings, while multiple windings connected in a parallel configuration will share the current. In this manner, multiple transformers can act as one if the primaries are connected in series and the secondaries are connected in parallel configurations, respectively. Just as energy present in a primary winding can induce energy within a secondary winding sharing the same core, energy produced in a secondary winding sharing the same core can induce energy into the primary, even if energy is already present, demonstrated by power distribution transformers and how they bi-directionally manage power to and from the power grid, depending on whether energy is present in the secondary independently from the primary. When no other equipment than a mere transformer is used, the energy is unmanaged and cannot be controlled so as to prevent unintentional “back-fed” energy from a generator back into de-energized electrical power lines during a period of maintenance—which is considered a problem in the context of electric power distribution as unintentionally energized power lines can present a hazard to power line maintenance personnel.

FIG. 3 illustrates one embodiment of the invention. The figure's illustration represents a fully functioning circuit that adopts the functionality of the transformer illustration in FIG. 2 with significant feature capabilities. By incorporating solid-state components, the size and role of the traditionally designed transformer core(s) is reduced as control is introduced to the energy passing to and from the circuit. For discussion and illustrative purposes, Roman Numeral Headers over each Stage of the invention's schematic layout were made to serve in correlation to FIG. 4, which represents the affects on the waveforms being created for each respective direction (primary-to-secondary or secondary-to-primary). FIGS. 3a, 3b, 3c, 3d, 3e, 3f, 3g, 3h, and 3i are each magnified views of one ninth of FIG. 3.

FIG. 4 demonstrates the voltage and power waveforms present within the reference Stage, again with the Roman Numeral Headers that correspond directly to FIG. 3. The waveforms correspond to the levels of voltage and power over time as it passes through various parts of the circuit. The levels can correspond to the voltage, power or the current since, as noted in the “Preface to Stage Discussions” below, the current is kept in phase with the voltage in each waveform within the reference circuit (ideally using power factor correction technology), and the power as the product of the voltage and current conforms to the same in-phase waveform of each.

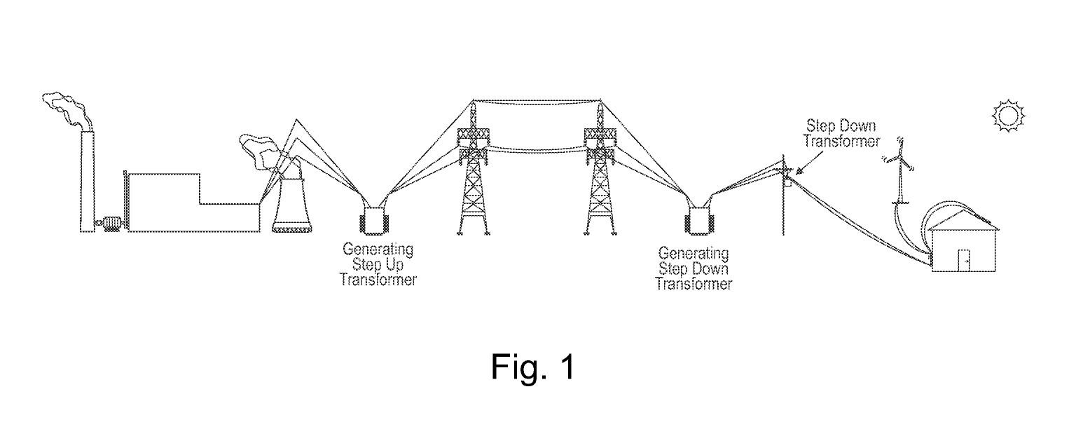

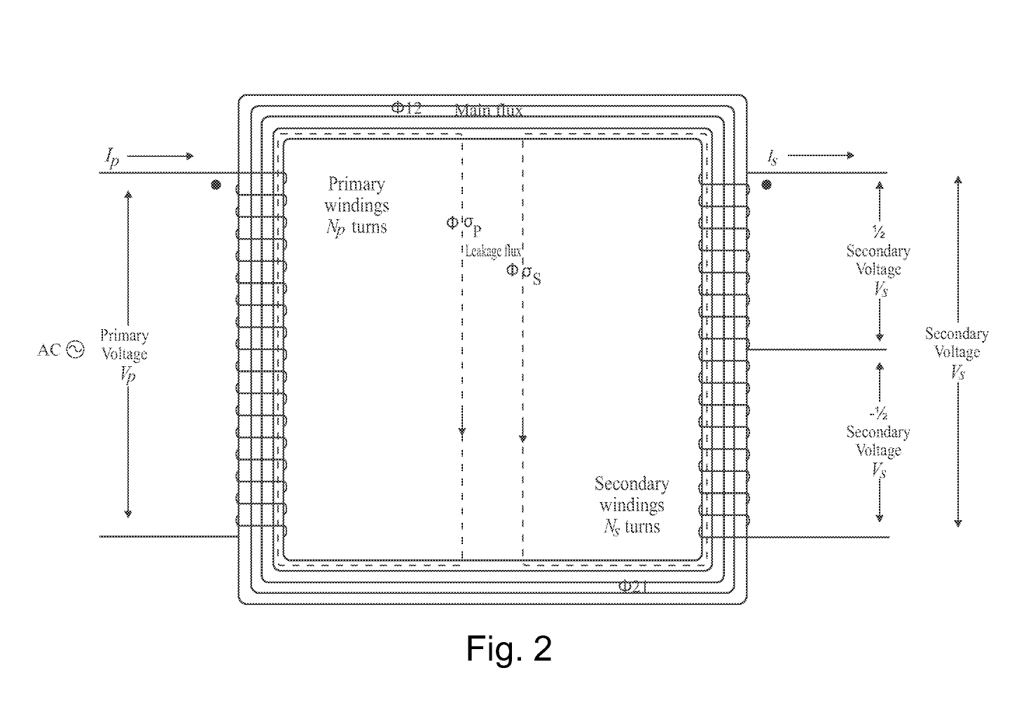

### DETAILED DESCRIPTION OF THE INVENTION, DRAWINGS, AND ILLUSTRATIVE EMBODIMENTS

### Control Circuitry

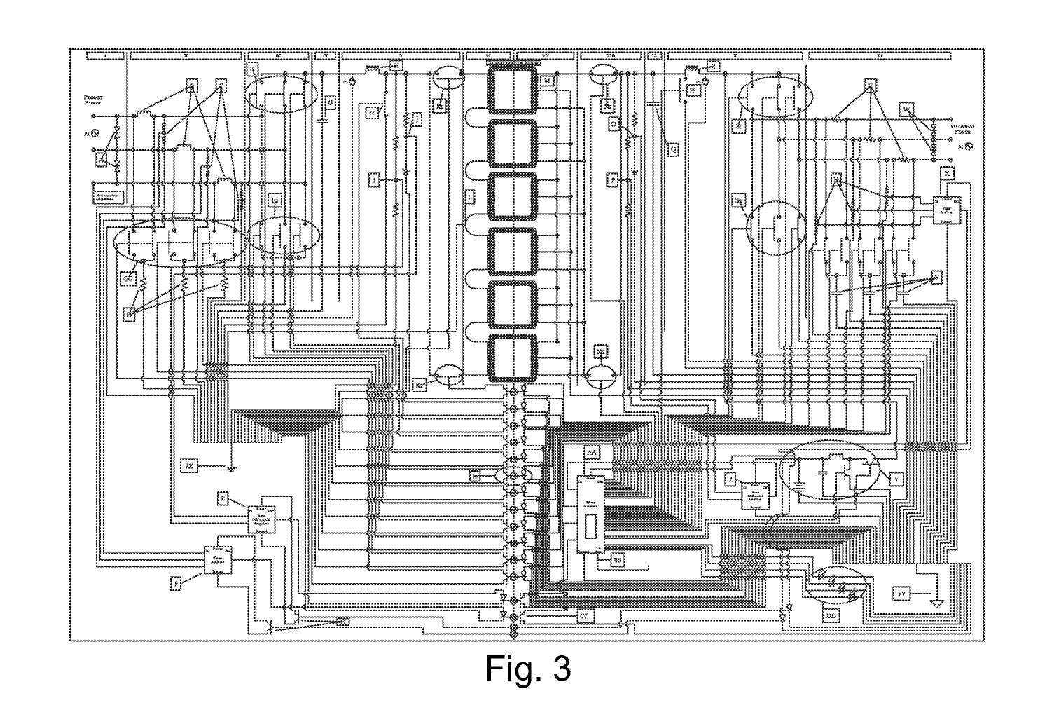

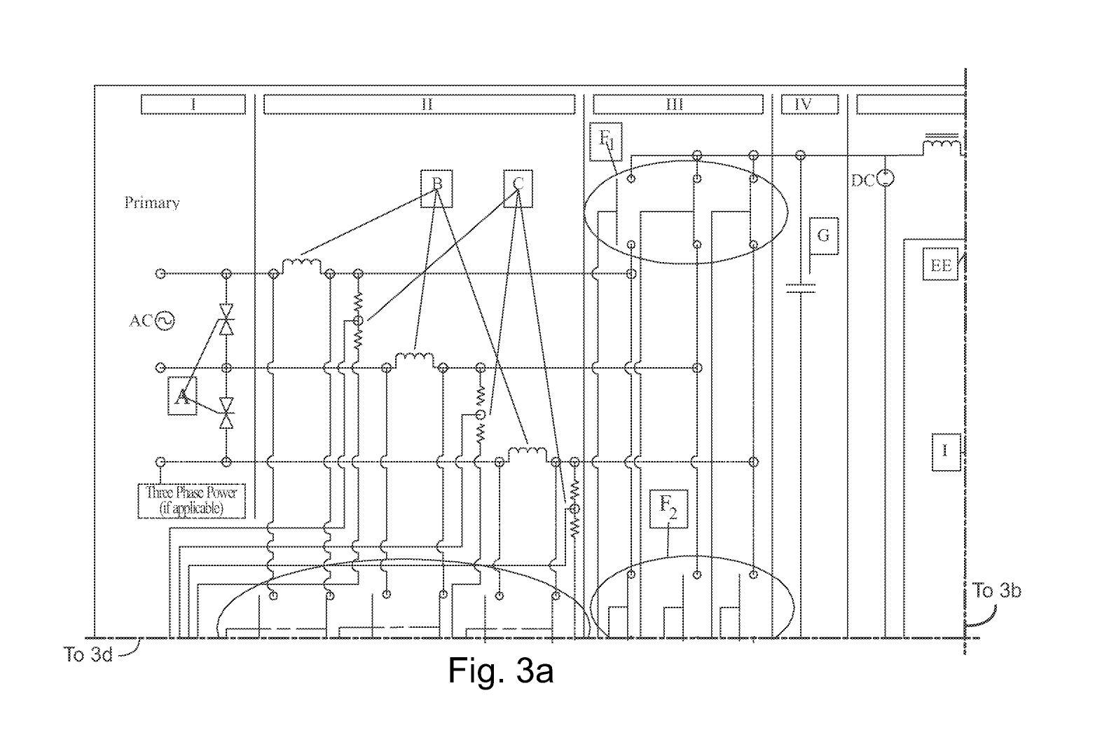

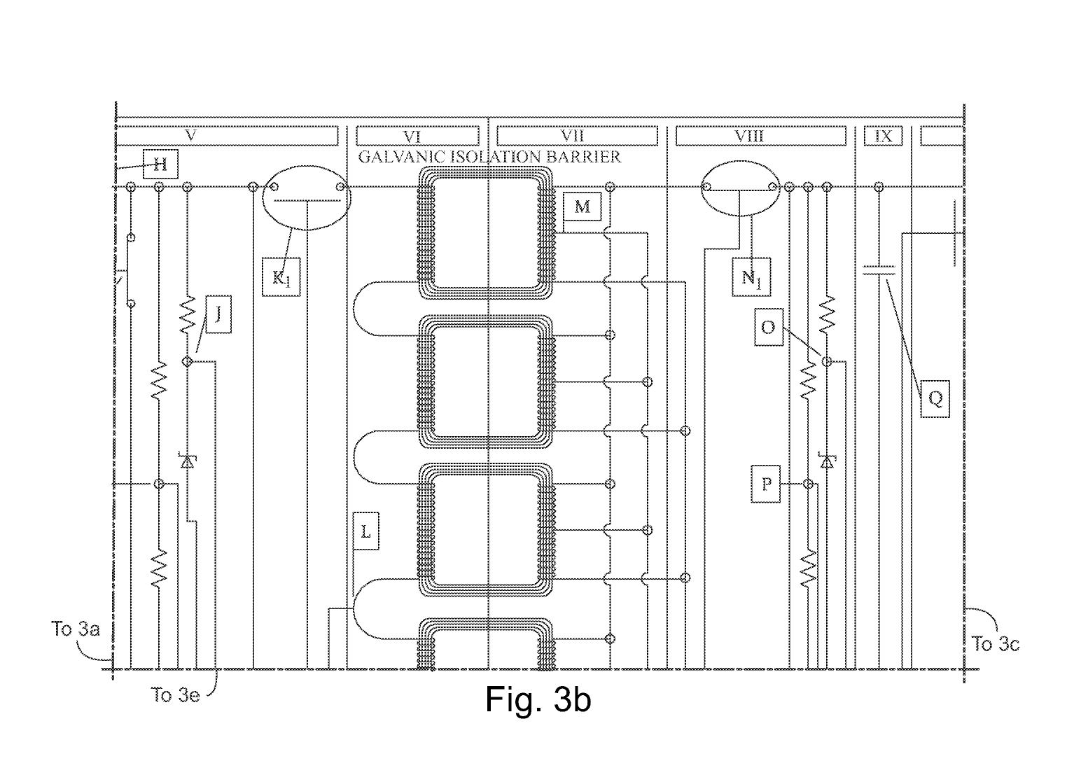

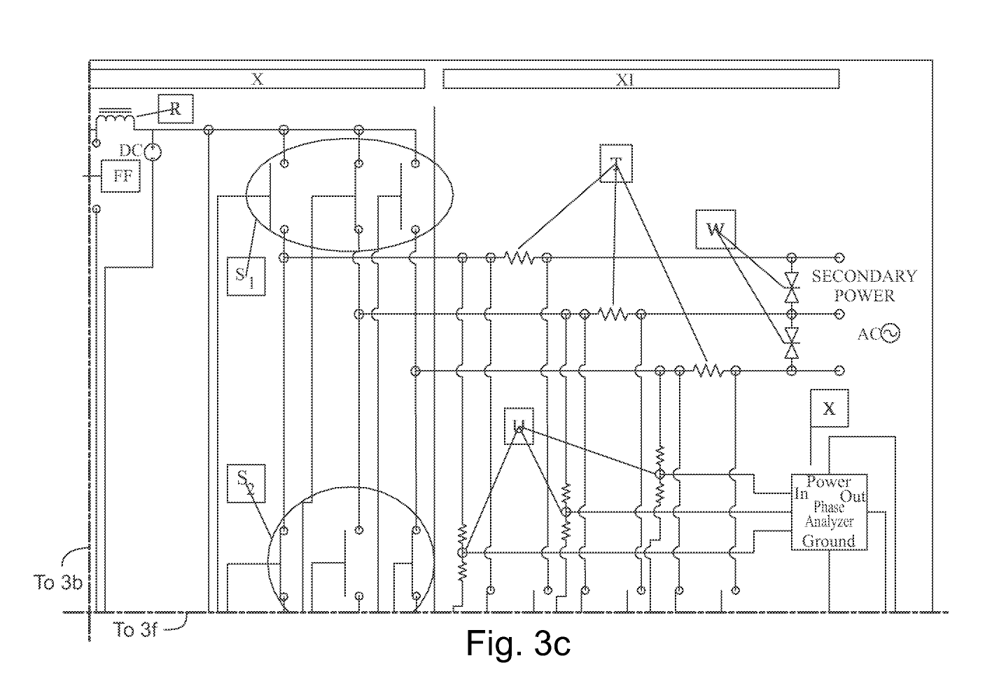

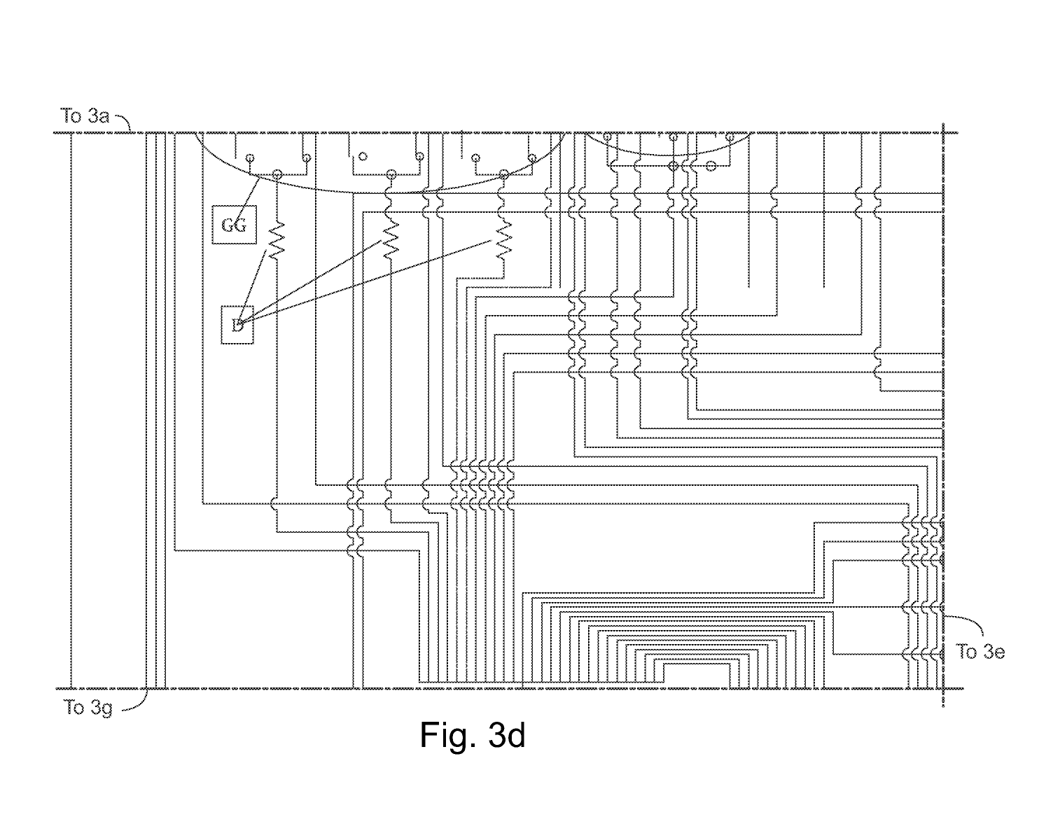

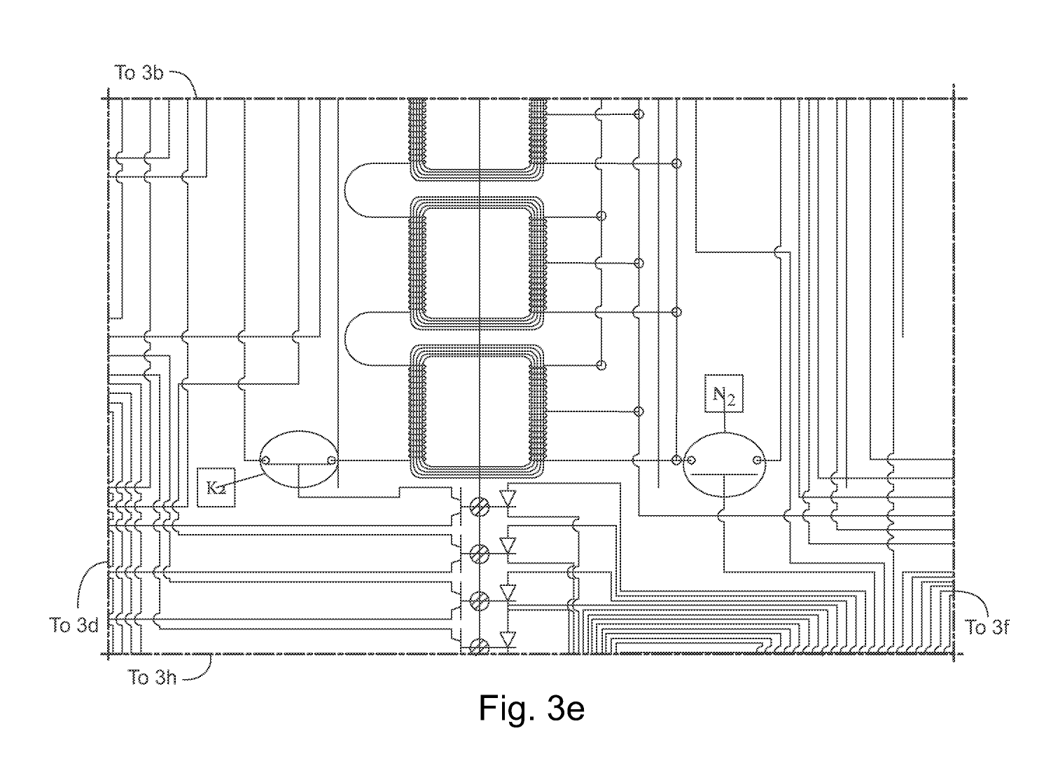

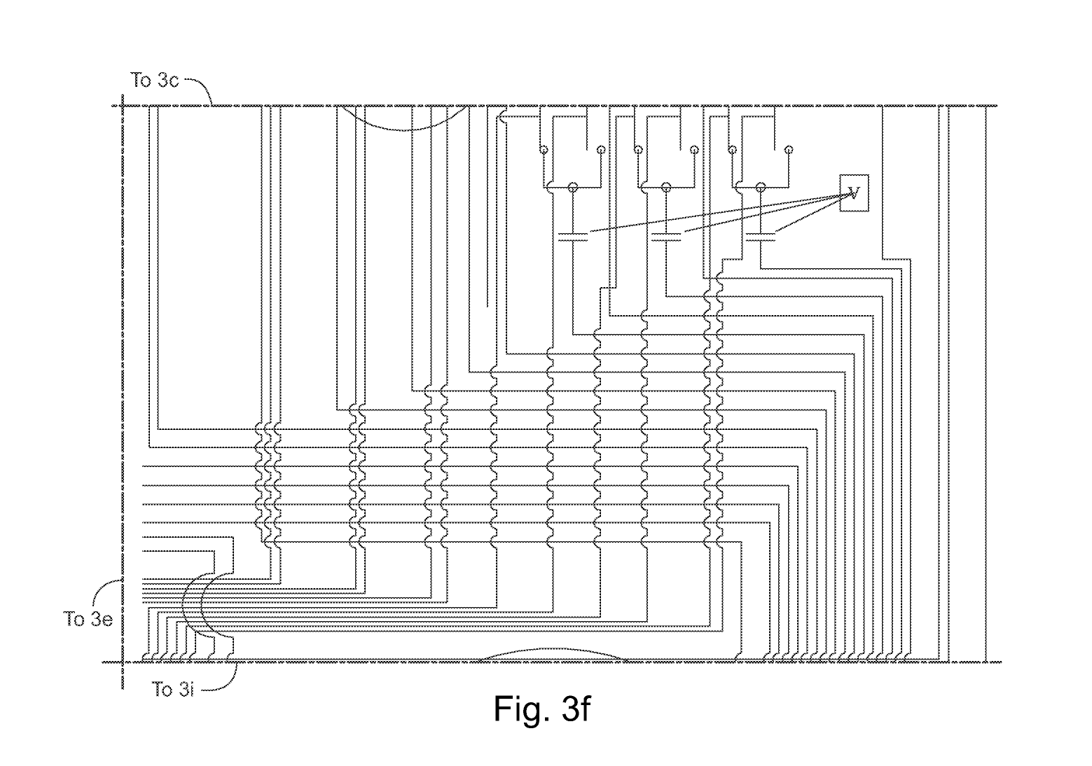

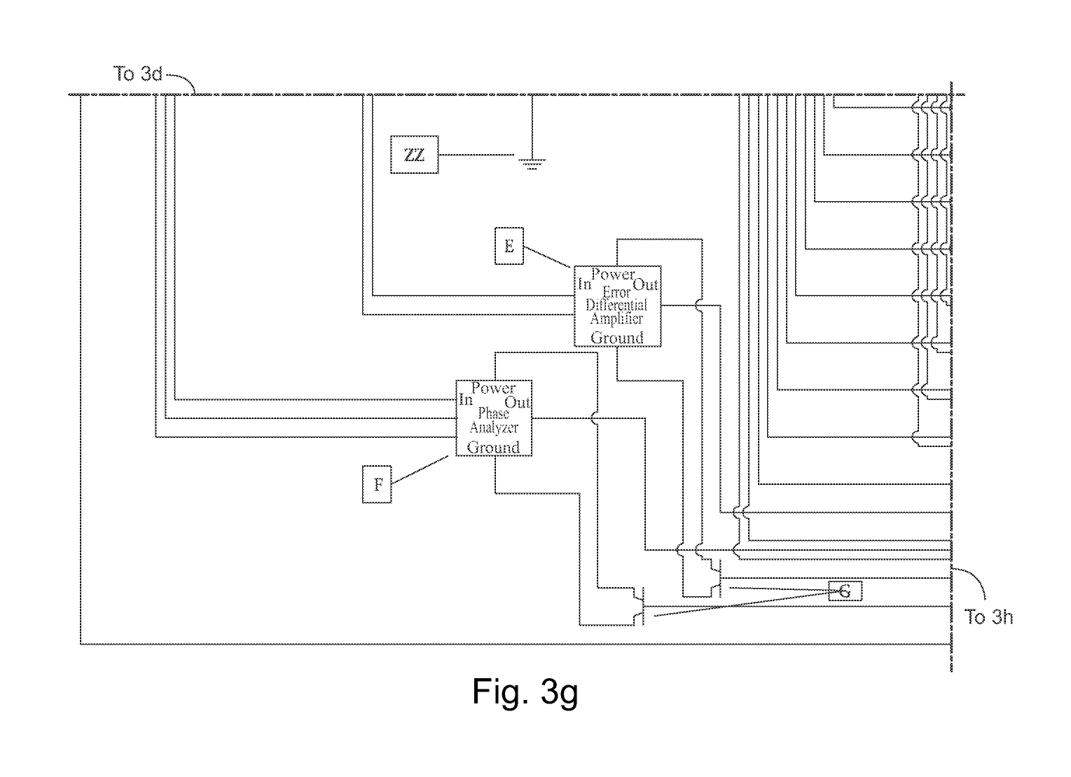

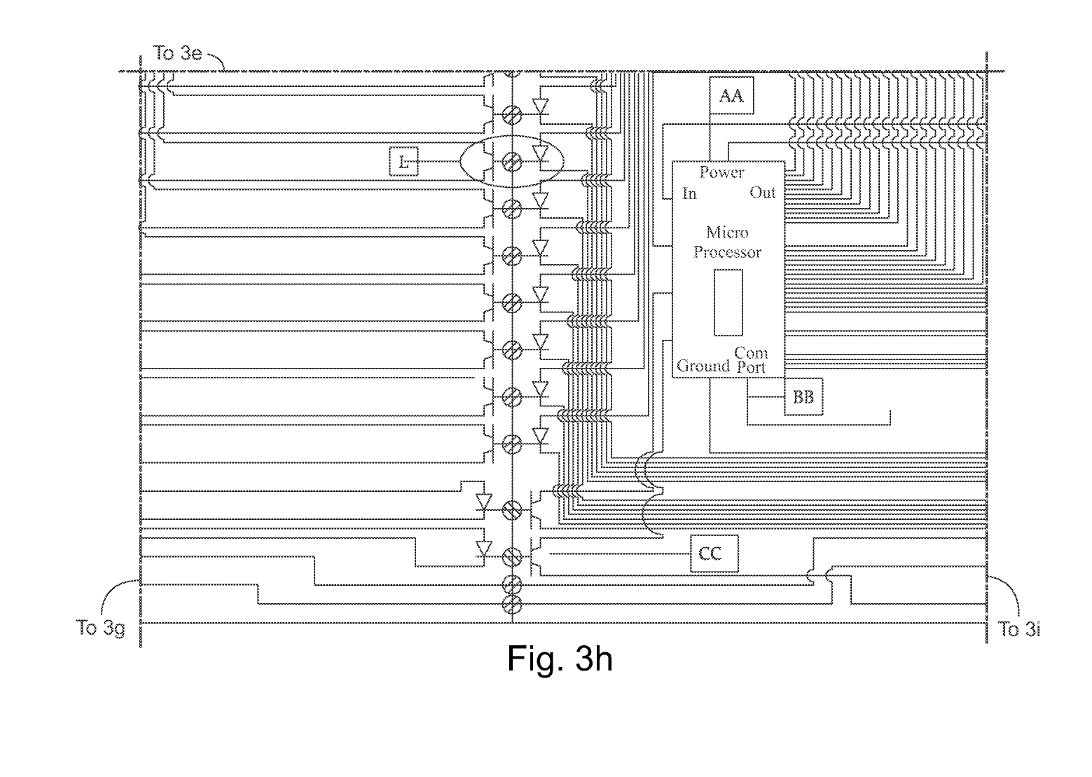

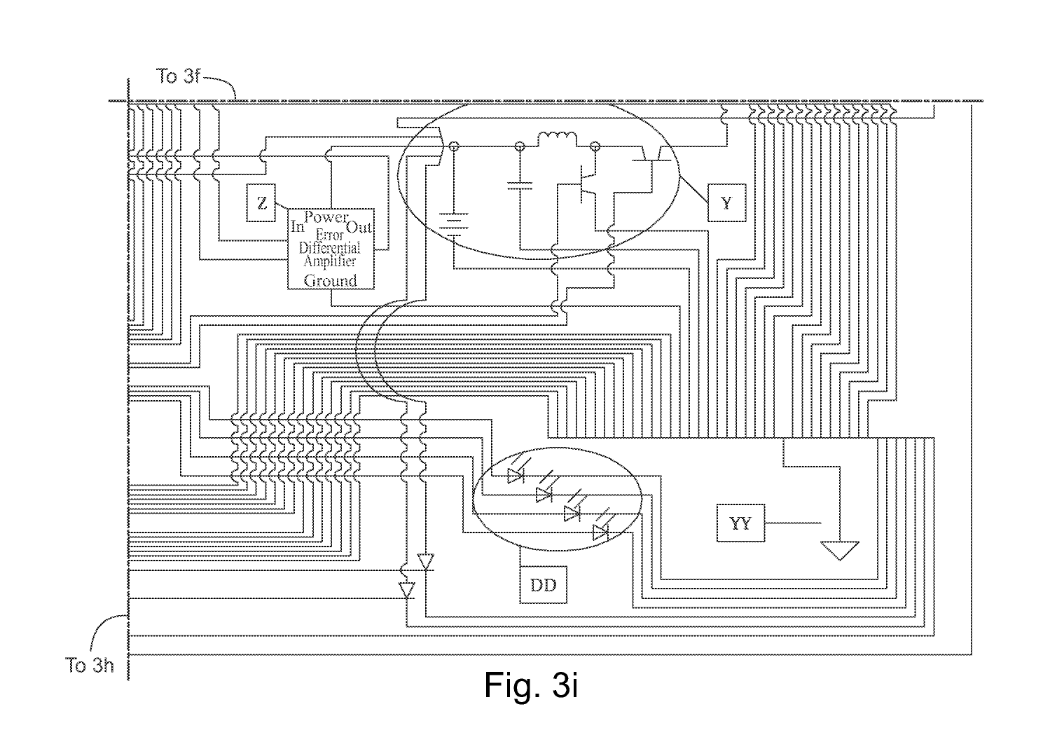

References to the invention's control circuitry will be made throughout. Based on information from its various monitoring sensors & analyzers, as well as its communication interface from outside of the device, the main processor (by means of microprocessor or microcontroller) FIG. 3 (AA) controls the switch positions (open/close) and the respective timing of these positions in relation to one-another throughout the device. Collectively, this is referred to as the control circuitry.

The control circuitry main processor is positioned on the secondary side with sensor and analyzer components on both primary and secondary sides, as well as a communications bus. All monitoring, sub-component powering, control and communications that cross the galvanic isolation barrier are provided through optically isolated connections (also referred to as optoisolators or optocouplers, depending on function) or an equivalent isolation component.

In the absence of main processor functioning, ALL switches are set to “fail safe” operations whereby ALL switches are set to an “open” position.

### Control Circuitry: Start-Up Sequence & Powering

The control circuit is designed to power itself from a rechargeable on-board integrated energy storage source (such as a battery or high-value capacitor) FIG. 3(Y) until the device's primary or secondary connections are energized.

During this “ready to engage” stage, the device will consume minimal amounts of power required to function until energized by at least one external energy source.

When the device's primary or secondary side is initially energized, the device's main processor will sense “peak” voltage (either DC voltage measurement or AC voltage peak) from the primary side phase analyzer FIG. 3(F). This is similar to the device's “black-out” routine, which is triggered following a complete removal of power on the primary side. If a removal of power from the primary side occurs while the secondary side connections remain energized, the device will cease to convert energy from secondary-to-primary in order to prevent “backfeed” onto the power distribution grid.

This “peak” voltage value will be stored in the main processor's memory and referenced during the operation of the device for the purpose of switching secondary power to primary power in order to maintain the correct peak voltage.

Once the device is energized, it will begin control switching using the power of its onboard energy source to energize the secondary side DC bus. Once the secondary side DC bus is energized, the device will power itself from the secondary DC bus and recharge its onboard secondary backup energy source for continued operation.

Power for the control circuitry is represented FIG. 3 (Y) as having two parallel sources: a low-voltage secondary energy source (high-value capacitor or battery) and a DC-DC buck converter. Operation of the device is initially provided by the secondary energy source, typically device startup resulting from a new installation or operation recovery from a lack of primary or secondary power. Primary power from the DC-DC buck converter takes over operation after energized and recharges the secondary supply in parallel.

Similar to present-day's actions requiring transformer “tap settings,” the secondary side of the device's main processor will be configured before or during deployment to reference a defined voltage and output phase relationship to utilize during primary-to-secondary energy conversion, provided the configuration does not exceed the ratings of any components used within the device (including the primary side's).

During secondary-to-primary energy conversion, any power entering from the secondary is permitted as long as the power level does not exceed component ratings. The secondary energy will be converted to power on the primary side with a level set by the voltage peak sensed by the device. In this case the energy output on the primary side will be controlled to match the phase, frequency and peak of the existing primary power.

Should a different secondary power level or phase relationship between secondary connections be desired after deployment, the main processor's software can be re-configured to accommodate the desired levels through various methods; including but not limited to: wireless re-configuration, control module replacement, wired device communication, frequency or amplitude modulated communication through an existing power connection.

Control circuit components located on the primary side of the device will receive their power through an optically-isolated power bus connected to the secondary side preventing any conductors from crossing the galvanic barrier FIG. 3 (G) created by the transformer(s) or other isolated means of power.

“Black-out routine” code within the main processor's software is triggered following a complete removal of power on the primary side. If a removal of power from the primary side occurs while the secondary side connections remain energized, the device will cease to convert energy from secondary-to-primary in order to prevent “backfeed” onto the power distribution grid.

### Control Circuitry: Normal Operations

During operation, the primary side control circuit senses the voltage on the DC rail of the primary side via a voltage divider in the illustrated reference circuit FIG. 3 (I) and compares that voltage with a voltage reference FIG. 3 (J) (ideally provided via a Zener diode regulator). The actual circuit can use another means of potential measurement if more efficient. The difference between the measured voltage and reference voltage is relayed via optoisolator FIG. 3 (CC) to the main processor as a low-amplitude PWM signal sourced from a fixed or sweeping frequency oscillator FIG. 3 (E) located on the primary side's low-voltage circuitry.

The primary control circuit can also assume the role of measuring the instantaneous amplitude of the primary voltage waveform via voltage sensor FIG. 3 (C) and change the state of Stage V's power factor correction circuit's switch FIG. 3 (EE) in order to keep the current draw of the primary side components in phase with the primary side voltage during primary-to-secondary operation.

Alternatively, the primary side circuit can simply measure and relay this information to the main processor for it to handle and switch components appropriately.

With exception to the main processor which manages both primary and secondary sides, the control circuit placed into service on the primary side is effectively duplicated on the secondary side for similar power factor correction during secondary-to-primary operation FIG. 3 (U and FF).

The secondary side components also perform phase analysis FIG. 3 (X) on the secondary side voltage waveform for secondary-to-primary operation.

The control circuitry will be powered from an onboard secondary energy source while in a low-power “standby” state until either the primary or secondary connections of the device are energized, after which the control circuit will begin to control its own switching regulator to power itself from the secondary side DC bus FIG. 3 (Y).

Contrary to utilizing “tap controls” on present day's transformers, this invention's control circuitry allows for the automatic adjustment to variable primary (or secondary) voltages as preconfigured in the respective deployment application environment via the main processors' control software.

Upon detection of primary or secondary energy, the main processor will begin aligning the state of the switches in Stages III, V, VIII and X FIG. 3 (F1; F2; K1; K2; S1; and S2) of the device which allows the correct flow of energy from one side to the other.

The amount of power converted from primary-to-secondary or secondary-to-primary will be determined by the pulse width (“on time”) of each pulse over time, where a non-zero voltage pulse applied to a switch changes its state to permit flow of power.

The control circuitry monitors all of its on-board energy storage components in order to normalize all load changes over time.

Safety features include a remote “kill switch” so that an authenticated individual or system can remotely disable power conversion, in one or both directions of the device, should such a measure be deemed necessary.

Additionally, the tolerance of DC bus error differential is low enough to prevent a harmful drop in voltage (a/k/a “brown out”) on a given side of the circuit, but high enough so as to not trigger the “black-out routine” at zero-crossings of the alternating current that coincide with large load changes.

### Control Circuitry: Data and Information Processing

The control circuitry will have diagnostic capabilities embedded in the main processor's control software program with an interface for being queried or automatically relaying this information. Additionally, on-board LEDs will display variations of maintenance or failure modes by virtue of combinations of their color and illumination FIG. 3 (DD). In the event modifications are required to the main processor's control software program, remote connections can be provided with secured protocols in place to prevent unauthorized access FIG. 3 (BB).

Remote polling of usage logs and other data will allow the ability to more closely monitor energy demands. APIs (Application Programming Interfaces) with differing levels of authenticated access can be established for access in the monitoring of power usage or other data.

Multiples of this invention device can be sub-grouped over controlled and ad-hoc networks in order to normalize all load changes and their respective power demand encompassing every device within the relevant domain.

A current transformer or other measurement device may be located on the neutral line of the secondary (or primary) of the device in order to measure relevant currents pertaining to neutral energy for the purposes of energy usage monitoring and waste management.

The low-voltage control circuitry sensing is easily accomplished using low-current and thus negligible-loss voltage division using a simple pair of resistors which satisfy the equation:

$$= \frac{{V}_{out}}{{V}_{in}} = \frac{{Z}_{2}}{{Z}_{1} + {Z}_{2}}$$

The above resistor divider equation equates the ratio of output voltage over input voltage to the ratio of a resistor (ideally one closer to a lower potential than the other) over the sum of the two resistors being examined, though a single value may be the sum of one or more resistors in series or parallel. The complex transfer function taking frequency as an argument is equated to this ratio to factor in alternating currents.

The result for direct currents is a reduction in the direct current potential, while the resulting voltage for alternating currents is the input alternating current waveform with reduced peak amplitude (as demonstrated by the transfer function).

### Preface to Stage Discussions

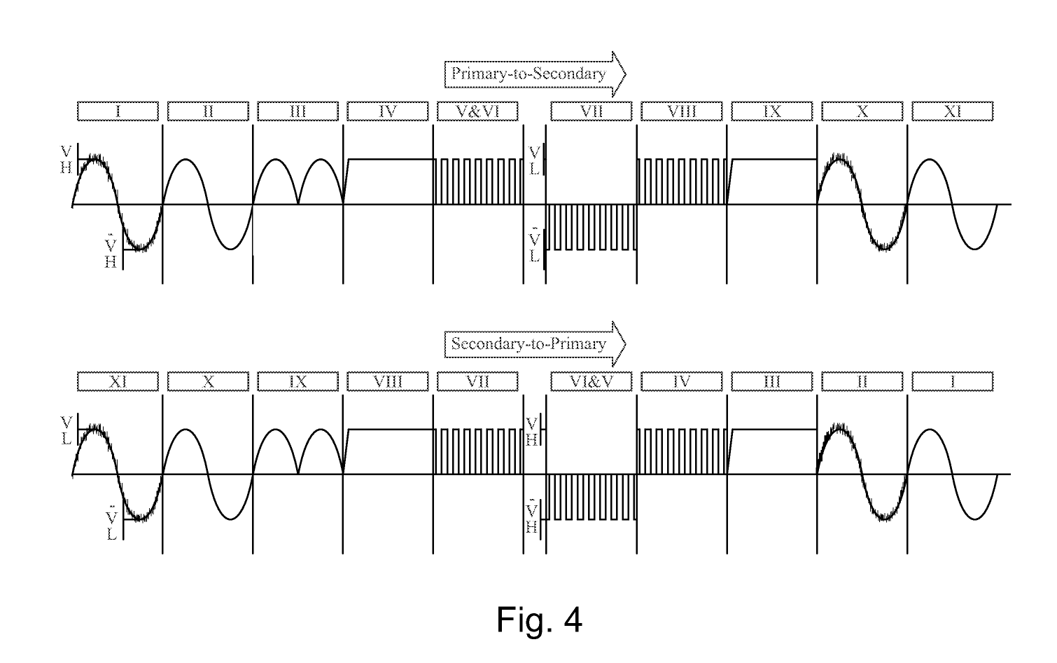

The Roman Numeral Headers in FIG. 3 and FIG. 4 correspond to one another and represent the Stage of the voltage/current as it passes through the invention's processing. FIG. 4 represents both directions of energy conversion waveforms as they pass through the respective device processes.

Although this invention is a bi-directional device, the discussion below will be as though power will be flowing through the invention as represented in the FIG. 3 schematics from Stage I to Stage XI. The exact direction of energy conversion is dependent on whether energy is available from the secondary side as sensed by the control circuitry (details of which are covered above). Whether energy converts from primary-to-secondary or secondary-to-primary depends on the load(s) connected to any connection and other variables factored in by the control circuit. Special notations may be made throughout the below descriptions regarding power flows from Stage XI to Stage I (secondary-to-primary).

In FIG. 4 current is “assumed” to be in-phase with the voltage thus equating voltage and current waveforms due to the presence of power factor corrective sub-circuits within the reference example in FIG. 3.

### Stage I

Stage I in FIG. 3 illustrates one or more primary power connection(s) to the present day alternating current power transmission and distribution system. Power derived from this source is normally alternating current (though direct current is permitted depending on the environment in which the device is deployed). In the normal case of an alternating current from the current power transmission and distribution system, one to three phases are connected along with a neutral connection, if present. Phase to phase (delta) power or phase to neutral power (wye) are both permitted on the primary side.

The primary power is of a higher potential compared to that of the secondary potential depicted in Stage XI. In the primary to secondary operation, power is converted in a step-down manner from primary connections input point(s) to the secondary connections.

Alternatively, in the case where power flows from secondary to primary, the primary connections are the output for power.

Immediately following the primary connections in Stage I are voltage suppression devices FIG. 3 (A). The introduction of these devices at this Stage will suppress temporary high voltage spikes that would otherwise exceed the ceiling voltage ratings of the primary side circuitry. Example implementation components are suitably rated GDTs (gas discharge tubes), TVS (transient voltage suppressors) or MOVs (metal-oxide varistors).

Correspondingly noted in FIG. 4, Stage I's power during primary-to-secondary operation is unfiltered and likely contains harmonic noise superimposed onto the line by non-filtering switching power supplies and the current drawn by non-resistive loads.

Conversely, Stage IX within FIG. 4's secondary-to-primary operation depicts a pure sine wave of noiseless ideal power due to the filtering sub-circuits illustrated within the reference circuit in FIG. 3—Stage 2.

### Stage II

Low-pass RL inductor-resistor filters FIG. 3 (B) are connected to each of the current-carrying lines of the primary connections. The resistor in the inductor-resistor FIG. 3 (D) pair is switched by a set of two high-potential switches FIG. 3 (GG), creating a current loop following the inductor, regardless of the direction of energy conversion.

The control circuitry will close one switch and open the other so that the resistor follows the inductor in either case to create a properly-configured low-pass filter. This low-pass filter attenuates higher-order harmonics of the primary power's fundamental frequency from the circuit before passing the power on to the next stage of the circuit.

Substitutions for low-pass RL filter at this Stage may be chokes or other forms of bi-directional filtering to suppress noise, provided the noise is suppressed by current coming in or current leaving the device.

As energy continues the primary-to-secondary flow, following the switched RL filter are voltage dividers FIG. 3 (C) attached to each current-carrying line of the primary connections. These resistor dividers act as sensor inputs and step down the voltage into a low-amplitude, low-current draw, in-phase waveform mirroring the primary connections. The output of the resistor divider (the midpoint connection between the two resistors) is the primary side control circuitry for sensing the time-dependent value of the primary power for switching purposes.

These sensors also allow power conversion from secondary-to-primary to be “in phase” with the primary connection(s) energy, if the primary is energized, or to halt secondary-to-primary current flow within the device's “black-out” routine.

The waveform depicted in FIG. 4 Stage II (primary-to-secondary flow) is a significantly improved “noise-free” sine wave containing only the fundamental frequency of the primary power as a result of the invention device's filtering. In reality, such a waveform would still contain some form of the previous stage's noise, but the objective of the filtering sub-circuit is to attenuate the noise's amplitude as much as possible before the rest of the device processes the power.

During secondary-to-primary operation, waveforms represented by FIG. 4 depict noise superimposed by the inverting switches, which is to be filtered before power leaves the device.

### Stage III

Primary side rectifier/inverter circuits are represented in Stage III. The circuit is best described as an H-bridge configuration of switches FIG. 3 (F1 and F2) controlled by the control circuitry. Each current-carrying (“live”) conductor connects between two high-power switches, with one connection of the switches per “live” conductor connected together in a parallel configuration, as per standard rectifier/H-bridge design.

For polyphase connections, the rectifier circuit in Stage III draws power uniformly from each live phase during primary-to-secondary operation.

Examples of switch implementations include high-power MOSFETs (metal-oxide semi-conducting field effect transistor) connected in an anti-parallel “analogue-switch” fashion, or high-power transistors connected with an anti-parallel “flyback” diode, where the diode rectifies primary side current in addition to protecting the transistors against power spikes during switching operation.

During this Stage's primary-to-secondary power conversion, the invention device rectifies the high-potential AC power present on each conductor into a DC waveform mathematically represented as the “absolute value” of the alternating current waveform present on the relevant primary connection, matching the frequency and phase of the primary power. The switch states are set by the control circuitry so that the current from a given live conductor always flows in the same direction for each of the live conductors passing non-reversing current into Stage IV.

During secondary-to-primary current flow, the switches' states are set by the control circuitry so that the DC current rail received from Stage IV creates alternating current across the primary connection(s). This alternating current will be matched in terms of phase, frequency and value of the sensed primary-connected alternating current.

In this manner, the switches operate as H-bridge inverters, and as such no two switches on either side of a midpoint-connected conductor are ever closed at once to prevent a low-impedance path for the current to flow outside of the primary connections (a “short circuit” or “crowbar currents”).

PWM (pulse-width modulation) can be used for the switching from the control circuitry in order to generate a low-THD (total harmonic distortion) waveform in phase with the primary side connections, with the switched RL filter in Stage II acting to attenuate any high-frequency noise from the switching. Alternatively, for the case of transistor switching, a low-potential sinusoidal current supplied by primary side control circuitry can be applied to a switch base or between gate terminals to invert DC current as high-quality sinusoidal power in phase with primary connection power.

FIG. 4's Stage III (primary-to-secondary conversion) waveform depicts a rectified alternating current sine wave, a non-alternating “absolute value” of the waveform present in Stage II of the preceding operation.

During secondary-to-primary current flow at this Stage III, the circuit depicts the pre-inverter direct current power as the rectified and filtered output of the high frequency transformer(s) output.

### Stage IV

A capacitor FIG. 3 (G) is centric at Stage IV in the primary-to-secondary operation. The capacitor is suitably rated for the high primary potentials involved on the primary side of the circuit, and is used to filter out the DC pulses into steady direct current, whether pulsating DC is received from the switches in Stage III during primary-to-secondary operation or high frequency pulsating DC is received from Stage V during secondary-to-primary operation.

Regardless of the direction of current flow, Stage IV ensures a low-ripple DC bus exists on the primary side for inversion by either Stage III or VI, depending on current direction.

In addition to an high dielectric strength material used within the capacitor to withstand the primary's high potential, the capacitor can have a high energy storage rating (ideally using a high-k dielectric constant material such as Calcium Copper Titanate) so that energy transferred/converted from one side of the circuit to the other is unaffected by temporary interruptions in current from either side.

The capacitor can either be a single monolithic unit (as is illustrated in FIG. 3), or represented by a series of capacitors depending on the application. Additionally, a capacitor used for the same purpose may be placed immediately following the filter in Stage V for the same purpose.

FIG. 4 Stage IV (primary-to-secondary conversion) depicts the graphical result of the capacitor on the circuit's power waveform, omitting low-amplitude “ripple-currents” unsuccessfully filtered by the capacitor due to the practical limitations of its size and function. The time-independent constant power level depicts direct current electricity in its purest form.

During secondary-to-primary current conversion at Stage IV depicts the rectified, unfiltered output from the high frequency transformer(s) that form the middle of the reference circuit.

### Stage V

A power factor correction circuit FIG. 3 (H and EE), sensors FIG. 3 (I and J), and high-frequency high-power inverter switches FIG. 3 (K1 and K2) are focal points at Stage V. First, the power factor correction circuit takes the form of a series inductor (or multiple series inductors acting as one) followed by a parallel-connected controlled switch. This creates a boost converter that forces the current drawn by the circuit to stay in phase with the voltage of the primary connections during primary-to-secondary power conversion, with a duplicate circuit present in Stage X for secondary-to-primary operation.

The power factor correction is present to compensate for the charge/discharge cycle of the capacitor(s) present in Stage V so the circuit as a whole, load-wise, appears to primary connections as a resistor during primary-to-secondary current flow.

During secondary-to-primary power conversion, the inductor's parallel switch FIG. 3 (EE) is kept open so that no current loop is present and the inductor acts strictly as a filter/energy storage unit for the conversion process. Switches can also be incorporated into the design to remove the inductor(s) from the circuit altogether via open state switch operation.

Ideally, the inductor(s) FIG. 3 (H) are suitably rated to properly resonate with the capacitor(s) in Stage IV to reduce losses and lower EMI emissions. However, any means of power factor correction may be employed in place of the depicted inductor configuration.

Preceding the primary side high frequency inverter switches FIG. 3 (K1 and K2) in Stage V, a sensor FIG. 3 (I) and a Zener regulator FIG. 3 (J) are connected between the positive and negative DC buses as a means to sense the instantaneous DC potential. The sensor is illustrated as a voltage divider, though any reliable means of measuring primary side DC bus potential can be employed (such as a current transformer). The Zener regulator acts to regulate the energy to a steady lower potential to act as references point for the primary side control circuitry to which it and the voltage sensor are connected.

This sensor configuration acts as an input to the control circuit so that the PWM-controlled switches set via the secondary side control circuitry in Stages V and VIII keep the primary voltage at a set level for the Stage III inversion process during secondary-to-primary operation.

The Stage V sensor configuration acts as input to a primary side control circuitry Phase Analyzer FIG. 3 (F) sub-circuitry. This sub-circuitry is also responsible for detecting the “peak value” of the primary side voltage.

As primary-to-secondary operation continues its conversion, Stage V concludes with a set of high-frequency switches, illustrated in a “push-pull” topology (though others can be employed for a given implementation). These switches FIG. 3 (K1 and K2), each connected to the positive side of the DC bus, alternate in open/closed state as set by the control circuitry with enough latency between state transitions to eliminate potential “crowbar currents” from shorting out the primary side of the circuit and causing a device failure.

During secondary-to-primary current conversion the switches in Stage V act as high frequency synchronous rectifiers with the inductor functioning as a resonant energy storage element.

FIG. 4 illustrates the 180-degree phase shift that power waveforms undergo when crossing the Galvanic Isolation Barrier. This is due to the effect's of Faraday's Law of Induction, which occurs during the transition of energy to and from both sets of windings and the transformer core(s) to which they are wound. While power is conserved during this process, other than negligible losses, the amplitude of the voltage is modified according to the ratio of turns from one winding to the next in both directions, accommodating both primary-to-secondary operation as well as secondary-to-primary operation.

### Stage VI

Stage VI forms one-half of the Galvanic Isolation Barrier through the use of its primary wound transformer segment(s).

The high-frequency AC power output from Stage V's switches flows into one or more transformer primaries. The illustration in FIG. 3 depicts multiple high frequency transformers utilized with the primaries connected in series to divide the voltage amongst them, for the case where a single transformer with suitable ratings is not feasible to deploy.

The centermost point FIG. 3 (L) between all of the windings is connected to the negative side of the primary DC bus to which power can flow as a reference point following conventional current flow during primary-to-secondary operation. This same negatively connected center tap also allows for the use of Stage V's switches FIG. 3 (K1 and K2) to create a two-switch full wave bridge rectifier.

Additionally, complex implementations may require one or more different levels of conversions of power. Conventionally addressed by “tap changers” on today's transformers, this is addressed in Stage VI as sets of switches connected around different points along the transformer's primary winding(s). This creates a solid-state switched taps to be changed as needed by the control circuitry during power conversion.

FIG. 4's Stage VI illustration depicts high-potential high-frequency pulsed AC power, which illustrates the power flowing into the transformer(s) primary winding(s). The power flowing in or out of the primary winding(s) is of an opposite sign (or 180 degrees out of phase) to the power flowing to or from the transformer(s) secondary winding(s), due to Faraday's Law of Induction applied to transformers.

### Galvanic Isolation Barrier

Between Stage VI and Stage VII of FIG. 3 lies what is referred to within this document as the galvanic isolation barrier. This virtual barrier is formed by the transformer(s) depicted in Stage VI and VII, specifically where the core(s) of the transformer(s) forms the non-conducting bridge between the primary side components in Stage VI and the secondary side components in Stage VII.

For the purposes of FIG. 3's illustration, this galvanic isolation barrier creates a centric reference point within the device that places all of the primary components on the left of the barrier and the secondary side components to the right of the barrier.

No metallic conductors cross this barrier except the transformer(s) itself. Energy from the device's power conversion process only crosses this barrier as magnetic energy within the transformer(s) core(s). This design creates a safety mechanism whereby no faults present on one side of the device have a direct conductive path to the other. This is a required feature of power supplies implemented by this device for safety and reliability reasons.

The only other energy forms passing from the primary or secondary sides of the device to the respective other are in the form of light using optical isolation components called optocouplers. Optoisolators FIG. 3 (L) and optocouplers FIG. 3 (G) are used within the low-voltage control circuitry for data transfer and powering the phase analyzer and error differential amplifier sub-circuitry devices, respectively. A “class Y” capacitor crossing the barrier for the purpose of low-leakage power conversion is an exception to this requirement.

FIG. 3's transformer array depicts multiple connected transformers to achieve the high-frequency DC-DC conversion process. Alternative single or multiple transformer variations are possible (provided proper windings and calculations). The transformer(s) will have a higher turn ratio on the side(s) illustrated in Stage VI than in Stage VII, since the potential of the primary will be larger than that of the secondary.

Based on the high frequency being switched in Stages V and VIII, the transformers will generally have a significantly smaller footprint than allowed under the current deployed transformers in non-switching power converters. If multiple transformers are used, the primaries are connected in series preventing the individual voltage rating of each transformer to not exceed the control circuitry's reference voltage on the DC bus of the primary side, regardless of the flow of energy conversion.

Connecting the negative side of the DC bus to the midpoint of the transformer(s) FIG. 3 (L) directs the current to flow through the transformers in a “push-pull” configuration during primary-to-secondary conversion. Simultaneously, two switches FIG. 3 (N1 and N2) perform full bridge rectification of the energy received from the secondary side during secondary-to-primary conversion. This topology, as shown is an ideal reference implementation as it enables feasible high-power, bidirectional conversion of energy within the context of the solid state switching within the device.

### Stage VII

This stage depicts the secondary side connections of the transformer(s) that comprise the Galvanic Isolation Barrier. In the illustrated circuit, multiple transformers are used with the secondaries connected in a parallel configuration so that the current is evenly shared between them. This configuration can be replaced by a single transformer with ratings suitable for the operation of high secondary currents, in addition to high primary voltages.

The center tap FIG. 3 (M) within the transformer(s) secondary connection is connected to what will become the secondary side circuitry's negative DC bus, while the opposing windings at the farthest point from the secondary, carrying high-frequency puled AC voltage, will be received by Stage VIII's switches FIG. 3 (N1 and N2) for rectification.

FIG. 4 depicts Stage VII in the same manner as it does Stage VI albeit with different voltage amplitude as a result of the transforming action performed. Stage VII's high frequency alternating current will be of a lower potential than Stage VI's high-frequency alternating current, though the frequency will be matched to that of Stage VI's frequency and the phase will be off by 180 degrees.

### Stage VIII

At this Stage, the secondary side sensor elements FIG. 3 (P and O) are positioned mimicking similar functions of the primary side. The control circuitry measures the secondary side DC bus potential via the Error Differential Amplifier FIG. 3 (Z), and then controls Stage V and VIII's switches with appropriate pulse widths to maintain the voltage regardless of operation mode.

The switching elements FIG. 3 (N1 and N2) in Stage VIII rectify the output from the secondary windings of the transformer(s) during primary-to-secondary operation, or to invert the secondary side DC bus to high-frequency power entering the secondary side of the transformer(s) during secondary-to-primary operation.

Stage VIII within FIG. 4 on the primary-to-secondary operation corresponds directly to Stage IV within the secondary-to-primary operations described above, albeit with differing amplitude: the high frequency, phase-shifted output from the transformer(s) is rectified to form the basis for unfiltered direct current.

Stage VIII under the secondary-to-primary operations of FIG. 4 depicts the filtered output of the high-frequency rectifiers on the high-voltage primary side of the circuit, which is pure high voltage direct current. The high voltage direct current as described herein is different in long-distance power transmission, which is typically a significantly higher order of magnitude in amplitude, though the same can be utilized within this circuit and device given suitable components.

### Stage IX

The capacitor(s) FIG. 3 (Q) illustrated in Stage IX filters out any ripples from the high-frequency rectification during primary-to-secondary operation. It also functions as a reservoir energy storage element during secondary-to-primary operation. For the purpose of energy storage, another capacitor may be located within Stage X on the other side of the power factor corrective circuit from the capacitor(s) in Stage IX.

Stage IX in FIG. 4 within the primary-to-secondary operation illustrates the filtered secondary side high frequency rectifier output. This is low voltage direct current to be inverted into alternating current.

FIG. 4's secondary-to-primary operation Stage IX depicts the rectified alternating current received from the secondary side of the circuit's connection(s), provided alternating current is the secondary side's power waveform instead of direct current.

In the event of direct current being connected directly to the secondary side of the device, Stage IX through XI of the secondary-to-primary operation waveform would resemble Stage VIII. Amplitude may differ before the power factor corrective boost converter (Stage X) and ripple current, including possible harmonics that may be present until the Stage IX.

### Stage X

Similar functioning to that of Stage V, power factor correction circuitry contained in Stage X is designed to keep current draw in phase with voltage during secondary-to-primary operation. During primary-to-secondary operation, the switch FIG. 3 (FF) is left open and the inductor FIG. 3 (R) (or alternative) acts as a secondary side energy storage element recommended for push-pull topologies.

The illustrated secondary side power factor correction unit, not unlike the illustrated reference PFC unit in Stage V, also serves as a regular DC boost converter if non-nominal DC current is present from the secondary conductors.

Stage X is also equipped with a set of low-potential, high-current switches FIG. 3 (S1 and S2) in an H-bridge configuration. The switches act similarly to those in Stage III by inverting the secondary side DC rail into sinusoidal alternating current during primary-to-secondary operation, or rectifying secondary power to direct current (which will be filtered by Stage IX's capacitor(s) FIG. 3 (Q) during secondary-to-primary operation.

The switches provide single or polyphase sinusoidal alternating current with a very low total harmonic distortion via PWM switching or a sinusoidal base/gate current. Alternately, split-phase primary-to-secondary operation can also be achieved by the control circuitry performing a series of actions beginning with keeping one set of switches open between the positive DC bus conductor and secondary connected “neutral” conductor. The switch would be closed between the “neutral” conductor and negative DC bus conductor in order to effectively split the current in half between the other two secondary conductors and the neutral conductor.

The secondary conductors will carry sinusoidal alternating current with the same frequency as the primary side conductors, though the phase can be independent. The remainder of the circuitry in this Stage ensures that current draw from primary-to-secondary or secondary-to-primary is in phase with the time-dependent energy source so the device appears to the energy source as a resistive load.

In the case of inductive or capacitive loads connected to the secondary, normally wasted current will be rectified to power the secondary side DC bus and lower the amount of energy required from the primary side of the circuit. This can be accomplished by using IGBT transistors with antiparallel flyback diodes to rectify the incoming secondary current or switching the neutral conductor's H-bridge switch states to rectify the power as it is present in a synchronous fashion.

FIG. 4's Stage X primary-to-secondary operation notes the alternating current waveform to be output from the secondary connections of the device with harmonics superimposed on the waveform due to the noise of the inverter switches. Stage X on the secondary-to-primary operation reflects filtering an AC waveform of power received from the secondary connections of the device.

### Stage XI

This final primary-to-secondary operation contains secondary side voltage sensors FIG. 3 (U) similar to that of the primary side.

Following the sensors in Stage XI are low-pass filters, depicted as RC (resistor-capacitor) filters FIG. 3 (T) with the capacitors FIG. 3 (V), switched for bi-directional operation. FIG. 3's depicted switch states reflect primary-to-secondary operation, with the reversed state of the switches connected to a particular capacitor indicating their state for secondary-to-primary operation.

Regardless of operational direction, the low-pass filter in Stage XI is designed to remove higher-order harmonics from conductors in order to shield the device from the power sources' harmonic noise during secondary-to-primary operation, or to shield loads from noise generated by the device during primary-to-secondary operation.

Voltage spike suppressors FIG. 3 (W) are placed in Stage XI to reduce severe voltage spikes, mainly for secondary-to-primary operation, similar to those deployed in Stage I.

Following the voltage spike suppressors in Stage XI are the secondary power connections, from which flows energy during primary-to-secondary operation and into which flows energy during secondary-to-primary operation.

Stage XI of FIG. 4's primary-to-secondary operation depicts the secondary connection(s) alternating current power supplied from the device, with all inverter noise filtered away by the reference circuit's secondary side low-pass filter.

Stage XI in FIG. 4's secondary-to-primary is the unfiltered waveform of low-amplitude alternating current electricity entering the device. The waveform depicted represents alternating current (not direct current) with superimposed harmonic noise.

### Example 1

### Single Phase Power Distribution Transformer

The functionality described can be used in place of a pole or pad mounted power distribution transformer, typically installed by electric utility companies to step down high voltage power distribution lines to power levels suitable for residential use within homes and small businesses.

The new device will accept a single energized distribution voltage-level high voltage line, wired either between the energized line and a distributed neutral/ground connection (Wye) or between two energized phases of polyphase high voltage power.

The microprocessor/microcontroller would be preset with the standard voltage on which to maintain on the secondary side DC rail, e.g. 314 volts of direct current for US split-phase residential service drops (the product of the square root of two and the root-mean-square voltage of 240 volts).

Upon connection, the device will measure and reference the primary side DC bus voltage since the distribution voltage may vary from region to region (currently addressed via “tapping” on current power distribution transformers), then operate to convert the high voltage primary energy to the set level of low-voltage secondary energy for use by the power customer.

If the event a utility customer connected to the device generates energy (solar panels, wind, etc.) and the primary connection is in a powered state, the utility customer's energy will be inverted from the secondary side to the primary side in order to feed energy back into the power distribution system.

The unit is capable of being remotely “powered off” (provided secure access is established) for more efficient and faster management of power access by the utility company.

### Example 2

### Three-Phase Power Distribution Transformer

For businesses and residences requiring three phase electrical power, the device can be configured to accept one to three energized lines (single or polyphase) of high voltage power distribution lines, and convert that energy to three or more phases of low or medium voltage for use in powering polyphase loads.

The device would operate largely the same as in Example 1, with the primary difference being the larger amount of input and output power connections. The secondary DC bus may require a higher voltage setting to accommodate the level of polyphase energy needed on the secondary side of the circuit, which can either be set at the time of manufacture or changed at any time by swapping the control circuit module or remote software code modification following authentication.

Secondary-to-primary operation would be controlled by the control circuit to carefully ensure that each phase of primary connections are powered with the same current to alleviate phase power imbalances and to compensate for any existing grid-level phase power imbalances. Likewise, the primary-to-secondary conversion process would draw power evenly from each energized high voltage line for the same reasons.

A single unit comprising of polyphase circuitry would suffice for one or more polyphase service drops, as opposed to the use of multiple single-phase units as described in Example 1 above. Remote powering (also referenced in Example 1 above) is applicable herein.

### Example 3

### Regenerative Variable Speed Drive

Energy harvesting applications (regardless of scale) is possible as evidenced in this example wherein the device is applied to electromechanical devices such as variable speed fans. Accepting one or more phases of power on the primary side, the device converts that energy to one or more phases of secondary power at a variable frequency over time. Special notation: Three phases are ideal for most electromechanical motors, though single-phase power may be the only feasible source for some applications.

When used in this application, the device can increase or decrease the frequency as needed while adjusting power factor correction on the primary and secondary sides of the circuit for even load balancing on the power network.

Following an abrupt shut-off, such as an air conditioning unit being switched off manually (or timer control), the fan's mechanical motion can be utilized by the device to enter secondary-to-primary energy flow to re-supply the local energy network. Presently, energy from these devices has been dissipated as mere friction by the fan's spinning rotor.

This is best visualized as a fan or other rotor-stator electromechanical device that outputs three-phase electric power on its secondary side regardless of primary power type. During device regeneration mode where secondary-to-primary energy flow takes places as described above, the device functions as a generator to replenish energy back into the power network.

In addition to the behavior described, the device's control circuitry can be configured to halt primary-to-secondary energy consumption and enter secondary-to-primary energy production at any point in time. This trigger could be based on the detection of a drop in energy on the primary side that would indicate a sudden increase in the load(s) connected to the primary's power network at a particular instance in time. This secondary-to-primary operation replenishes energy demanded from the network and mitigate load changes in order to maintain higher power quality.

### Example 4

### Surge, Power Correction, and Uninterruptible Power Supply

Utilized in conjunction with a large capacity secondary energy storage unit on the device's secondary side (having sufficient scale for the application), deployment of this device at a hospital (or similar campus environment) would be made with the objective of powering secondary connected loads should the primary connection lose its energized status, per industry backup power supply design.

Within nanoseconds of the primary side losing its energy (or failure to supply a given threshold of power), the device would utilize the energy from the fully charged secondary energy source to power devices connected to it's secondary connections. Virtually instantaneous, backup power generators would be started. Until such time as the backup generators are fully energized, reaching an adequate supply level, the secondary power from this device would be utilized.

Utility companies (within operating agreements with the campus) could balance the primary connected power distribution network's supply power using energy from this device during secondary-to-primary operation. This could apply during times of sudden load increases or other power phenomena that would affect the power quality for the entire primary connected power network.

This example would not supply energy from a secondary energy source so as to “defeat the purpose” of a secondary energy storage driven uninterruptible power supply, instead utilizing peak charges down to a safe threshold of charge depletion in order to maintain a “good” power quality across the entire primary connected power distribution network as well as to maintain the secondary energy storage unit over time through regular charge-discharge cycles, which can be configured to be “smoothed” over the cells of the secondary energy source should it be composed of individual cells.

### Example 5

### Localized Surge, Power Correction, and Uninterruptible Power Supply

Similar to the Example 4, this device (on a smaller scale) can be used alone or in conjunction with a large capacity secondary energy storage unit (uninterruptible power supply) positioned on the secondary side of the circuit. This “smaller than a bread basket” device targets the consumer market with the purpose of powering secondary connected loads with properly balanced power should the primary connection lose its energized status, per standard uninterruptible power supply design.

The control circuitry's solid-state design allows for corrected balanced power performance. Within nanosecond detection of the primary side losing energy (or failing to supply a given threshold of power), the control circuitry utilizes the energy from the fully-charged secondary energy source to maintain the energy to the secondary connected devices.

While the foregoing written description of the invention enables one of ordinary skill to make and use what is considered presently to be the best mode thereof, those of ordinary skill will understand and appreciate the existence of variations, combinations, and equivalents of these specific embodiments. The invention should therefore not be limited by the above described embodiments, but shall include all embodiments within the scope and spirit of the invention.

1. A bi-directional electricity system comprising:
(a) solid-state components;
(b) means for controlling the direction of electricity flow across the system.

2. The system of claim 1 further comprising:
(a) means for managing one or more parameters of said electricity flow.

3. A method of managing electricity comprising the steps of:
(a) measuring one or more parameters of two or more electric lines;
(b) controlling the direction of electricity flow based on said measurements;
(c) powering one or more of said electric lines.

4. The method of claim 3 further comprising the steps of:
(a) measuring one or more parameters of two or more electric lines;
(b) controlling the direction of electricity flow based on said measurements;
(c) converting said electricity flow to a first current rail;
(d) passing said electricity flow through one or more magnetic elements;
(e) converting said electricity flow to a second current rail;
(f) converting said electricity flow to one or more power specifications;
(g) powering one or more of said electric lines.
